(19) United States
(12) Patent Application Publication
(10) Pub. No.: US 2011/0122116 A1
(43) Pub. Date: May 26, 2011

(54) TRANSFLECTIVE LIQUID CRYSTAL DISPLAY DEVICE AND DRIVING METHOD THEREOF

(75) Inventors: CHIH-LUNG LIN, Miao-Li County (TW); RUI-JIE HSIANG, Miao-Li County (TW); I-AN YAO, Miao-Li County (TW); YING-LING CHEN, Miao-Li County (TW)

(73) Assignee: CHIMEI INNOLUX CORPORATION, Miao-Li County (TW)

(21) Appl. No.: 12/915,054

(22) Filed: Oct. 29, 2010

(30) Foreign Application Priority Data
Nov. 20, 2009 (TW) 98139442

(51) Int. Cl. G09G 5/00; G02F 1/136; G02F 1/1343

(52) U.S. Cl. 345/211; 349/43; 349/38

(57) ABSTRACT

A transflective liquid crystal display (LCD) device includes a plurality of pixel units, each pixel unit including a thin film transistor (TFT), a coupling capacitor, a first liquid crystal capacitor, and a second liquid crystal capacitor. The first liquid crystal capacitor is formed by a first common electrode, a liquid crystal layer, and a transmissive electrode, and the second liquid crystal capacitor is formed by a second common electrode, the liquid crystal layer, and a reflective area. The TFT is electrically connected to the first liquid crystal capacitor, and is also electrically connected to the second liquid crystal capacitor via the coupling capacitor.

### BACKGROUND

1. Technical Field

The present disclosure generally relates to display technology, and particularly to a transflective liquid crystal display (LCD) device and a method for driving the transflective LCD device.

2. Description of Related Art

Commonly used LCD devices have the advantages of portability, low power consumption, and low radiation, and are widely used in various electronic devices such as notebooks, personal digital assistants (PDAs), video cameras, televisions, and others.

Conventionally, there have been three types of LCD devices commercially available: a reflective LCD device utilizing ambient light, a transmissive LCD device utilizing backlight, and a transflective LCD device equipped with a half mirror and a backlight. With a reflective LCD device, a display becomes less visible in a dim environment. In contrast, with a transmissive LCD device, a display becomes hazy in strong ambient light, such as sunlight. In general, a transflective LCD device can be used as both a reflective LCD device and a transmissive LCD device by switching between a reflective mode and a transmissive mode according to the changes in the environment. Therefore the transflective LCD device is not hampered by problems of poor visibility and haziness, these problems being mitigated somewhat.

While commonly used transflective LCD devices include transmissive areas and reflective areas, due to limiting factors of optical design, display brightness on the transmissive areas is inconsistent with that on the reflective areas. Accordingly, a transflective LCD device having duel cell gap has been developed, having different heights of liquid crystal layer respectively in the transmissive areas and the reflective areas to optically compensate. However, the manufacture of the duel cell gap transflective LCD device is complicated. Therefore, another kind of transflective LCD device has been further developed, wherein, in each pixel unit, two thin film transistors (TFTs) are used respectively in a transmissive area and a reflective area of the pixel unit. Thus, the transmissive areas and the reflective areas are respectively driven by different signals to provide optimal display effect. However, the transflective LCD device requires doubled TFTs, which results in costs largely increasing.

What are needed, therefore, are a transflective LCD device and a driving method thereof which can overcome the described limitations.

### SUMMARY

A transflective LCD device includes a plurality of pixel units, each pixel unit including a thin film transistor (TFT), a coupling capacitor, a first liquid crystal capacitor, and a second liquid crystal capacitor. The first liquid crystal capacitor is formed by a first common electrode, a liquid crystal layer, and a transmissive electrode, and the second liquid crystal capacitor is formed by a second common electrode, the liquid crystal layer, and a reflective electrode. The TFT is electrically connected to the first liquid crystal capacitor, and is also electrically connected to the second liquid crystal capacitor via the coupling capacitor.

Other novel features and advantages will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views, and all the views are schematic.

FIG. 1 is a schematic cross-section of part of a transflective LCD device according to an embodiment of the present disclosure, the transflective LCD device including a plurality of pixel units.

FIG. 2 is a schematic circuit diagram of a pixel unit of the transflective LCD device of FIG. 1.

### DETAILED DESCRIPTION

Reference will now be made to the drawings to describe the preferred and exemplary embodiments in detail.

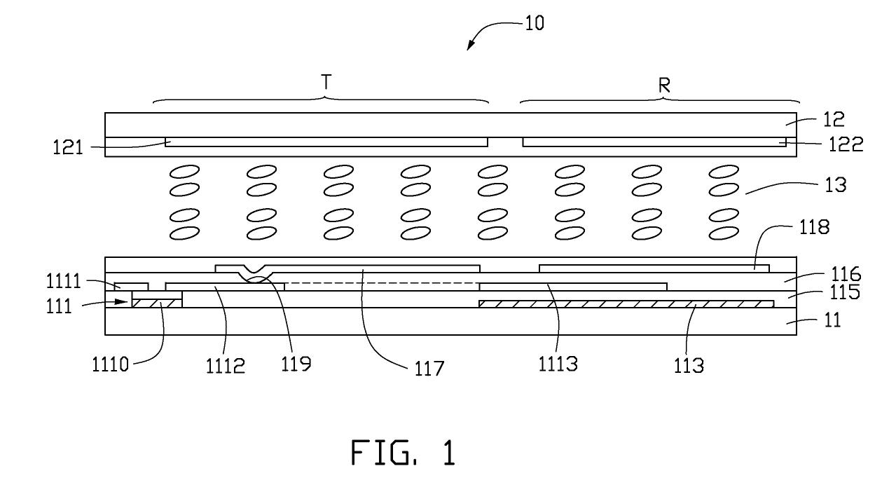

Referring to FIG. 1, a schematic cross-section of part of a transflective LCD device according to an embodiment is shown. The transflective LCD device 10 includes a first substrate 11, a second substrate 12 opposite to the first substrate 11, and a liquid crystal layer 13 sandwiched between the first and the second substrates 11, 12. The transflective LCD device 10 defines a plurality of pixel units, and each pixel unit includes a transmissive area T and a reflective area R. For simplification, a single pixel unit is shown in FIG. 1.

A TFT 111, a storage capacitor line 113, a first insulating layer 115, a second insulating layer 116, a transmissive electrode 117, and a reflective electrode 118 are formed on a surface of the first substrate 11 adjacent to the liquid crystal layer 13. The TFT 111 includes a gate electrode 1110, a source electrode 1111, and a first drain electrode 1112. The gate electrode 1110 and the storage capacitor line 113 are formed on the surface of the first substrate 11 at the same layer. The first insulating layer 115 is formed on the gate electrode 1110, the storage capacitor line 113, and the first substrate 11. The source electrode 1111 and the first drain electrode 1112 are formed on the first insulating layer 115 at the same layer. A second drain electrode 1113 is defined, and is formed on the first insulating layer 115 at the same layer simultaneously with the source electrode 1111 and the first drain electrode 1112. The second drain electrode 1113 may be the same material as the first drain electrode 1112. The second insulating layer 116 is formed on the source electrode 1111, the first drain electrode 1112, the second drain electrode 1113, and the first insulating layer 115. The transmissive electrode 117 and the reflective electrode 118 are insulated and formed on the second insulating layer 116 at the same layer. The second insulating layer 116 includes a hole 119 via which the transmissive electrode 117 is electrically connected to the first drain electrode 1112. The second drain electrode 1113 is electrically connected to the first drain electrode 1112, or the transmissive electrode 117 via another hole (not shown) of the second insulating layer 116. Part of the reflective electrode 118, the second drain electrode 1113, and part of the storage capacitor line 113 are disposed substantially to overlap each other perpendicular to the first and the second substrates 11, 12, and the other part of the reflective electrode 118 substantially overlaps the other part of the storage capacitor line 113.

A first common electrode 121 and a second common electrode 122 are insulated from each other, and are formed on an surface of the second substrate 12 adjacent to the liquid crystal layer 13 at the same layer. The first common electrode 121 corresponds to the transmissive electrode 117, and substantially overlaps the transmissive electrode 117 perpendicular to the first and the second substrates 11, 12. The second common electrode 122 corresponds to the reflective electrode 118, and substantially overlaps the reflective electrode 118 perpendicular to the first and the second substrates 11, 12. A gap between the first common electrode 121 and the second common electrode 122 may be less than a gap between the transmissive electrode 117 and the reflective electrode 118. Thus a fringe electric field may be generated at a portion adjacent to the gaps and improves a response time of liquid crystal molecules of the liquid crystal layer 13.

The transmissive area T corresponds to the first common electrode 121 and the transmissive electrode 117. The reflective area R corresponds to the second common electrode 122 and the reflective electrode 118. A thickness of the liquid crystal layer 13 corresponding to the transmissive area T is substantially the same as that corresponding to the reflective area R. That is, the transflective LCD device 10 is a signal cell gap LCD device. The transmissive electrode 117 is a transparent electrode, and light beams (may come from a backlight module) passing through the first substrate 11 can pass through the transmissive electrode 117 for display in the transmissive area T. The reflective electrode 118 can reflect light beams passing through the second substrate 12 and the liquid crystal layer 13 for display in the reflective area R.

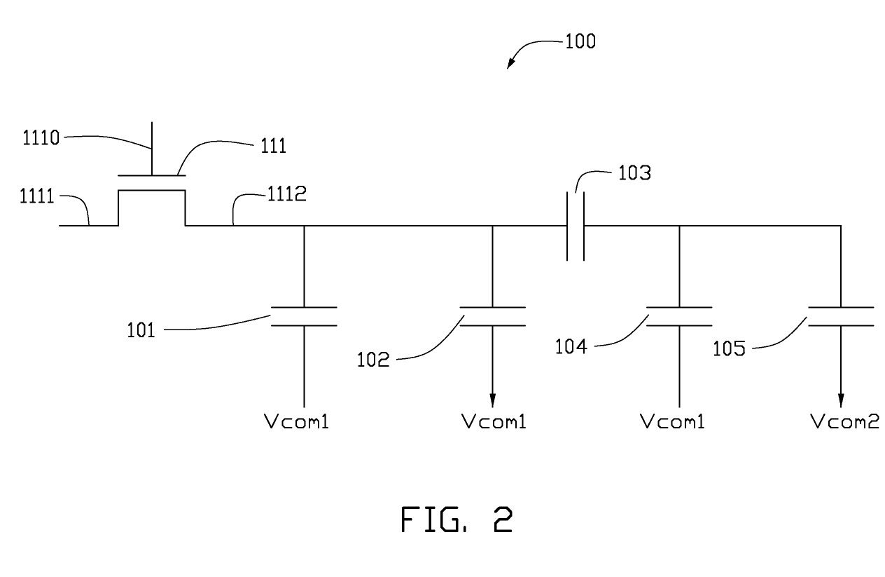

Referring also to FIG. 2, a schematic circuit diagram of one pixel unit of the transflective LCD device 10 is shown. The pixel unit 100 includes a first storage capacitor 101, a first liquid crystal capacitor 102, a coupling capacitor 103, a second storage capacitor 104, a second liquid crystal capacitor 105, and the TFT 111. The first drain electrode 1112 is electrically connected to the first storage capacitor 101 and the first liquid crystal capacitor 102, and is electrically connected to the second storage capacitor 104 and the second liquid crystal capacitor 105 via the coupling capacitor 103.

The coupling capacitor 103 is formed by the second drain electrode 1113, the second insulating layer 116, and the reflective electrode 118. The first storage capacitor 101 is formed by the second drain electrode 1113, the first insulating layer 115, and the storage capacitor line 113. The second storage capacitor 104 is formed by the reflective electrode 118, the first and the second insulating layers 115, 116, and the storage capacitor line 113. The first liquid crystal capacitor 102 is formed by the transmissive electrode 117, the liquid crystal layer 13 of the transmissive area T, and the first common electrode 121. The second liquid crystal capacitor 105 is formed by the reflective electrode 118, the liquid crystal layer 13 of the reflective area R, and the second common electrode 122.

When the transflective LCD device 10 is driven to display, the storage capacitor line 113 and the first common electrode 121 receive a first common voltage Vcom1, and the second common electrode 122 receives a second common voltage Vcom2. The first common voltage Vcom1 differs from the second common voltage Vcom2, in this embodiment, is lower than the second common voltage Vcom2. When the gate electrode 1110 of the TFT 111 receives a gate signal to be turned on, the source electrode 1111 receives a data signal. The data signal is provided to the transmissive electrode 117 via the first drain electrode 1112, and is also provided to the reflective electrode 118 via the coupling capacitor 103.

After the voltages are provided to the pixel unit 100, the first and the second liquid crystal capacitors 102, 105 start to charge. Before the liquid crystal molecules start to twist, a voltage Vlct on the liquid crystal layer 13 of the transmissive area T is less than or equal to a threshold voltage Vth when the liquid crystal molecules start to twist. After the liquid crystal molecules twist, the voltage Vlct on the liquid crystal layer 13 of the transmissive area T is greater than the threshold voltage Vth. Due to the coupling capacitor 103, a voltage Vr of the data signal received by the reflective electrode 118 is less than a voltage Vt of the data signal received by the transmissive electrode 117.

Because of Vlct=Vt−Vcom1, Vlcr=Vr−Vcom2, Vcom1<Vcom2, where Vlcr denotes a voltage on the liquid crystal layer 13 of the reflective area R, Vlct>Vlcr. Define Vlcr=m×Vlct+b, where m relates to the coupling capacitor 103, and m<1. Define b=(1−m)×Vth, where b relates to a difference between the first common voltage Vcom1 and the second common voltage Vcom2, and b>1. Thus, when Vlct=Vth, Vlcr=Vlct=Vth. When Vlct>Vth, because of Vlcr=m×Vlct+b=m×Vlct+(1−m)×Vth=m×(Vlct−Vth)+Vth, then Vth<Vlcr<Vlct.

Due to Vlct>Vlcr, a twist extent of the liquid crystal molecules in the reflective area R is less than that in the transmissive area T, a phase separation of the light beams twice passing through the liquid crystal layer 13 of the reflective area R can be substantially equal to that of the light beams once passing through the liquid crystal layer 13 of the transmissive area T. Thus, display brightness on the reflective area R is substantially consistent with that on the reflective area R. The first and the second common voltages Vcom1, Vcom2 can be adjusted according to need. For example, when m=0.5, and the difference between the first common voltage Vcom1 and the second common voltage Vcom2 is about 1.45V, the consistence of the display brightness on the transmissive area T and the reflective area R may be better. As well, the transflective LCD device 10 may show more gray levels in displaying dark state frames by adjusting the first and the second common voltages Vcom1, Vcom2 to make Vth<Vlcr<Vlct. Further, just one TFT is needed in each pixel unit, thus a process for manufacturing the transflective LCD device 10 is simple, at minimal cost.

It is believed that the present embodiments and their advantages will be understood from the foregoing description, and it will be apparent that various changes may be made thereto without departing from the spirit and scope of the embodiments or sacrificing all of their material advantages.

What is claimed is:

1. A transflective liquid crystal display (LCD) device, defining a plurality of pixel units, each pixel unit comprising a transmissive area and a reflective area, the transflective LCD device comprising:
a first substrate;
a second substrate opposite to the first substrate; and
a liquid crystal layer sandwiched between the first and the second substrates;
wherein each pixel unit comprises a thin film transistor (TFT), a transmissive electrode and a reflective electrode disposed on the first substrate, and a first common electrode and a second common electrode disposed on the second substrate, the transmissive electrode and the first common electrode correspond to the transmissive area, the reflective electrode and the second common electrode correspond to the reflective area, and the TFT is electrically connected to the transmissive electrode, and is also electrically connected to the reflective electrode via a coupling capacitor.

2. The transflective LCD device of claim 1, wherein the TFT comprises a gate electrode, a source electrode, and a first drain electrode, the TFT is electrically connected to the transmissive electrode via the first drain electrode, and each pixel unit further comprises a second drain electrode, the second drain electrode electrically connected to the first drain electrode and corresponding to the reflective electrode, and the second drain electrode and the reflective electrode forming two electrodes of the coupling capacitor.

3. The transflective LCD device of claim 2, further comprising a storage capacitor line, a first insulating layer, and a second insulating layer, wherein the storage capacitor line and the gate electrode of the TFT are disposed on the first substrate at the same layer, the first insulating layer is disposed on the storage capacitor line, the gate electrode, and the first substrate, the source electrode and the first drain electrode of the TFT, and the second drain electrode are disposed on the first insulating layer at the same layer, the second insulating layer is disposed on the source electrode, the first drain electrode, the second drain electrode, and the first insulating layer, and the transmissive electrode and the reflective layer are disposed on the second insulating layer at the same layer.

4. The transflective LCD device of claim 3, wherein the second drain electrode, the first insulating layer, and the storage capacitor line form a first storage capacitor, and the reflective electrode, the first and the second insulating layers, and the storage capacitor line form a second storage capacitor.

5. The transflective LCD device of claim 4, wherein the transmissive electrode, the liquid crystal layer of the transmissive area, and the first common electrode form a first liquid crystal capacitor, and the reflective electrode, the liquid crystal layer of the reflective area, and the second common electrode form a second liquid crystal capacitor.

6. The transflective LCD device of claim 3, wherein the second insulating layer comprises a hole, the transmissive electrode electrically connected to the first drain electrode via the hole.

7. The transflective LCD device of claim 1, wherein a gap between the first and the second common electrodes is less than a gap between the transmissive electrode and the reflective electrode.

8. The transflective LCD device of claim 1, wherein the transflective LCD device is a single cell gap LCD device.

9. A transflective liquid crystal display (LCD) device, comprising a plurality of pixel units, each pixel unit comprising a thin film transistor (TFT), a coupling capacitor, a first liquid crystal capacitor, and a second liquid crystal capacitor, wherein the first liquid crystal capacitor is formed by a first common electrode, a liquid crystal layer corresponding to a transmissive area, and a transmissive electrode, the second liquid crystal capacitor is formed by a second common electrode, the liquid crystal layer corresponding to a reflective area, and a reflective area, the TFT is electrically connected to the first liquid crystal capacitor, and is also electrically connected to the second liquid crystal capacitor via the coupling capacitor.

10. The transflective LCD device of claim 9, further comprising a first substrate and a second substrate opposite to the first substrate, wherein the liquid crystal layer is sandwiched between the first and the second substrate, the TFT, the transmissive electrode, and the reflective electrode are disposed on the first substrate, and the first common electrode and the second common electrode are disposed on the second substrate.

11. The transflective LCD device of claim 10, wherein the TFT comprises a gate electrode, a source electrode, and a first drain electrode, the TFT is electrically connected to the transmissive electrode via the first drain electrode, and each pixel unit further comprises a second drain electrode, the second drain electrode electrically connected to the first drain electrode and corresponding to the reflective electrode, and the second drain electrode and the reflective electrode forming two electrodes of the coupling capacitor.

12. The transflective LCD device of claim 11, further comprising a storage capacitor line, a first insulating layer, and a second insulating layer, wherein the storage capacitor line and the gate electrode of the TFT are disposed on the first substrate at the same layer, the first insulating layer is disposed on the storage capacitor line, the gate electrode, and the first substrate, the source electrode and the first drain electrode of the TFT, and the second drain electrode are disposed on the first insulating layer at the same layer, the second insulating layer is disposed on the source electrode, the first drain electrode, the second drain electrode, and the first insulating layer, and the transmissive electrode and the reflective layer are disposed on the second insulating layer at the same layer.

13. The transflective LCD device of claim 12, wherein the coupling capacitor is formed by the second drain electrode, the second insulating layer, and the reflective electrode.

14. The transflective LCD device of claim 13, wherein the second drain electrode, the first insulating layer, and the storage capacitor line compose a first storage capacitor, and the reflective electrode, the first and the second insulating layers, and the storage capacitor line compose a second storage capacitor.

15. The transflective LCD device of claim 14, wherein the transmissive electrode, the liquid crystal layer of the transmissive area, and the first common electrode form a first liquid crystal capacitor, and the reflective electrode, the liquid crystal layer of the reflective area, and the second common electrode form a second liquid crystal capacitor.

16. A method for driving a transflective liquid crystal display (LCD) device, the transflective LCD device comprising a plurality of pixel units, each pixel unit comprising a thin film transistor (TFT), a coupling capacitor, a first liquid crystal capacitor, and a second liquid crystal capacitor, the first liquid crystal capacitor formed by a first common electrode, a liquid crystal layer corresponding to a transmissive area, and a transmissive electrode, the second liquid crystal capacitor formed by a second common electrode, the liquid crystal layer corresponding to a reflective area, and a reflective area, the TFT electrically connected to the first liquid crystal capacitor, and also electrically connected to the second liquid crystal capacitor via the coupling capacitor, the method comprising:
providing a first common voltage to the first common electrode;
providing a second common voltage to the second common electrode;
providing a data signal to the transmissive electrode via the TFT when the TFT is turned on; and
providing the data signal to the reflective electrode via the coupling capacitor.

17. The method of claim 16, wherein the first common voltage is less than the second common voltage.

18. The method of claim 17, wherein two equations are defined by Vlcr=m×Vlct+b and b=(1−m)×Vth, where Vlcr denotes a voltage on a liquid crystal layer of the reflective area, Vlct denotes a voltage on the liquid crystal layer of the transmissive area, Vth denotes a threshold voltage when liquid crystal molecules of the liquid crystal layer start to twist, m relates to the coupling capacitor and m<1, and b relates to a difference between the first common voltage and the second common voltage and b>1.

19. The method of claim 16, wherein each pixel unit further comprising a first storage capacitor and a second storage capacitor, the TFT electrically connected to the first storage capacitor, and electrically connected to the second storage capacitor via the coupling capacitor.

20. The method of claim 19, wherein the first and the second storage capacitors are electrically connected to a storage capacitor line, the storage capacitor line receiving the first common voltage.
